(19) United States
(12) Patent Application Publication
(10) Pub. No.: US 2006/0112949 A1
(43) Pub. Date: Jun. 1, 2006

(54) Burner shield

(76) Inventors: John Ducate SR., Elgin, SC (US); John Ducate JR., Columbia, SC (US)

Correspondence Address: MCNAIR LAW FIRM, P.A., P.O. BOX 10827, GREENVILLE, SC, 29603-0827, US

(21) Appl. No.: 11/268,051

(22) Filed: Nov. 7, 2005

Related U.S. Application Data
(60) Provisional application No. 60/625,641, filed on Nov. 5, 2004.

(51) Int. Cl. F24B 3/00; A47J 37/00

(52) U.S. Cl. 126/25 R; 99/444

(57) ABSTRACT

The invention is directed towards a burner shield for placement between a grill's heat source and cooking surface. The burner shield comprises two sides connected to form a radiused peak. The burner shield includes protrusions that extend outwardly from at least one of the sides for inhibiting the flow of grease down one of the sides, increasing the time that the grease is in contact with the burner shield and thus the amount of grease that is vaporized. Vents may be defined by the protrusions and at least one of the sides for providing convection heating. The burner shield may include a upper arrangement of protrusions and a lower arrangement of protrusions that are off set from the upper arrangement so that grease flowing from or between the protrusions in the upper arrangement will contact at least one of the protrusions in the lower arrangement.

### CROSS-REFERENCE TO RELATED APPLICATION

This application claims priority on provisional patent application Ser. No. 60/625,641, entitled A COOKING APPLIANCE, filed Nov. 5, 2004.

### FIELD OF THE INVENTION

The invention is directed towards a burner shield for use with a cooking appliance and more specifically, a burner shield that can enhance the flavor of cooking foods.

### BACKGROUND OF THE INVENTION

It is well known that drippings, such as grease, make foods taste better when grilled. This fact is known for charcoal, gas, and other fueled grills. By collecting and vaporizing the excess grease that drips from the cooking food, the individual is able to enhance the flavor of the meal. It is advantageous to trap grease on a surface capable of vaporizing the grease to increase the amount of vapors that reach the meat being grilled. However, when using grills, temporarily trapping the grease on a surface hot enough to vaporize the grease can be difficult. Further, it is advantageous to protect the heat source, such as the burners, from being splattered with grease.

Traditionally, burner shields are used to provide some vaporization and protect the burners. Typically, these burner shields have a first and second side which define at least one peak, thereby creating generally an inverted “V” shape. However, these burner shields can accelerate the dripping grease and speed the grease flow reducing the amount of grease vaporized. Because the current burner shields lack a design that is aimed at slowing the rate at which the grease travels down the burner shield, much of the flavor from the grease vapor is lost.

Therefore, it is desirable to have a burner shield which is designed to keep the grease on the burner shield's surface for as long as possible before draining into the debris tray so that the maximum amount of grease is vaporized, thereby maximizing the flavor of the meat being grilled.

It is further desirable to have a burner shield that can be provided originally with a cooking appliance or can be provided subsequently to obtaining a cooking appliance and added to the cooking appliance.

### SUMMARY OF THE INVENTION

This invention is directed towards a burner shield for placement between the heat source a grill and the cooking area comprising a first side and a second side connected to form a radiused peak having generally an inverted V shape, the sides sloping outwardly from the radiused peak. The burner shield also includes a protrusion extending outwardly from at least one of the sides to help inhibit the flow of grease down at least one of the sides, increasing the time the grease is in contact with the burner shield and to help prevent grease from dripping on the heat source.

The burner shield may also include a vent defined by the protrusion and at least one of the sides allowing heat from the heat source to escape through the vent and into the cooking area. The protrusion may include a front portion partially obstructing the vent to help prevent grease from dripping on the heat source and may also include a left portion and a right portion for directing grease away from the vent.

The burner shield may include an upper arrangement of protrusions in generally a horizontally spaced configuration and a lower arrangement of protrusions in generally a horizontally spaced configuration and offset from the upper arrangement of protrusions so that grease traveling between protrusions of the upper arrangement of protrusions will contact at least one protrusion of the lower arrangement of protrusions.

The burner shield may include a flange carried by the first side and arranged generally upward from the slope of the first side. The first side of the burner shield may have a length less than the second side of the burner shield.

The invention may also include a plurality of integral sides angled to define a plurality of peaks and troughs and arranged generally in an undulating shape and having a protrusion extending outwardly from at least one of the plurality of integral sides to help inhibit the flow of grease down at least one of the integral sides, increasing the time the grease is in contact with the burner shield and to help prevent grease from dripping on said heat source. A vent may be defined in the burner shield by the protrusion and at least one of the plurality of integral sides.

The burner shield may further include at least one opening defined in the plurality of troughs for allowing grease that reaches one of the plurality of troughs to drain from the burner shield.

The burner shield may include a first exterior integral side and a second exterior integral side having a length less than the first exterior integral side. Additionally, the burner shield may have a first exterior integral side, a second exterior integral side, a plurality of interior integral sides wherein the first and second exterior integral sides have a length less than the plurality of interior integral sides.

### DESCRIPTION OF THE DRAWINGS

FIG. 1 is a perspective view of a grill having a burner shield;

FIG. 2 is a perspective view of an alternate embodiment of a burner shield;

FIG. 3 is a side elevation view of a burner shield; and

FIG. 4a is an end view of one embodiment of a burner shield; and,

FIG. 4b is an end view of one embodiment of a burner shield.

### DETAILED DESCRIPTION OF THE INVENTION

Typically, cooking appliances comprise a housing, a burner assembly, a cooking area, a heating area, a debris trap, and a heating source, such as charcoal or gas. The cooking assembly housing or frame may be a standard grill housing having four sides, a bottom, and a flip-top lid.

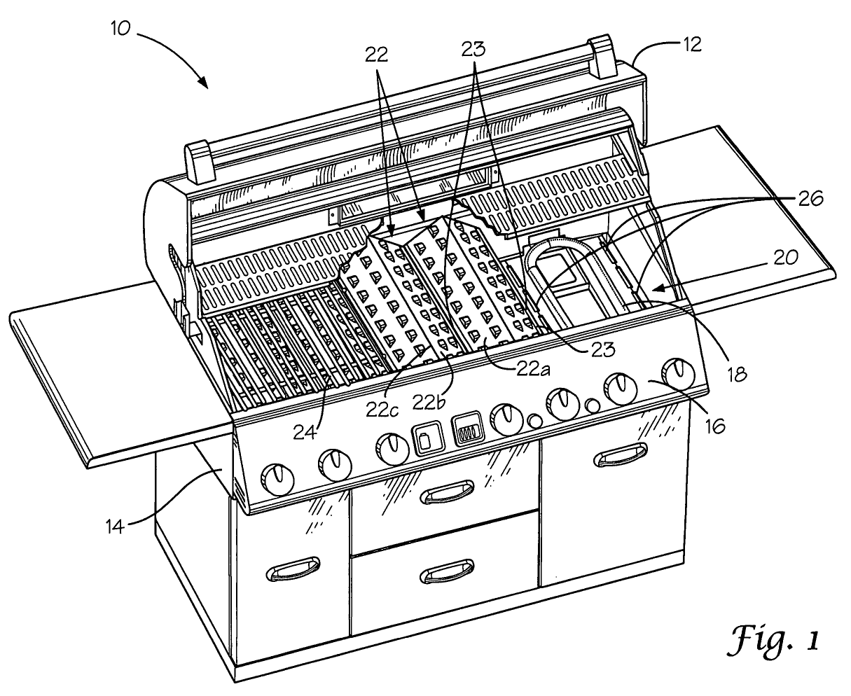

Referring now to FIG. 1, a cooking appliance is shown generally as 10 and includes an upper-lid flip-top lid 12 that is hingeably connected to frame 14 in such a fashion that the flip-top lid is able to be easily opened and closed. The cooking appliance can include a burner assembly 16 that includes at least one burner 18 having a plurality of ports for the excretion of gas. The burner assembly is carried by frame 14 in such a fashion that at least one burner 18 extends into the heating area shown generally as 20. Burner assembly 16 can be connected to a gas tank by a gas line. The gas tank may have a variable setting knob, which controls the rate at which the gas exits the gas tank to the burner assembly through the gas line. The cooking appliance may also employ charcoal as a heat source or other fuels.

Located above one burner 18 of burner assembly 16 is a burner shield 22. The burner shield is located below cooking surface 24, but above burner 18. The burner shield comprises a first side 22a and a second side 22b that are connected at an angle to form a radiused peak. First side 22a and second side 22b slope away from the radiused peak 30 to define a generally inverted “V” shape. Located at the outer edge of either or both of the first and second side is a flange 23, that is angled upward from one or both of the downward sloping sides 22a and 22b. In at least one embodiment, the flange is angled so that is generally parallel to cooking surface 24.

When placed adjacent to one another, several burner shields can define a plurality of peaks. Further, when arranged in such a horizontally spaced relation, flanges 23 provide a space that can be located over drip openings 26 that are disposed between burners 18 of burner assembly 16. Because the burner shields need not be integral with one another, the excess grease that is not vaporized by burner shield 22 is allowed to drain off of flanges 23 and into drip openings 26. In such an arrangement, burner shield 22 is carried by the frame and may be attached to the frame via hooks, slots, snaps or the burner shield may rest on a lip that extends from the frame or may be carried by other means known by those skilled in the art.

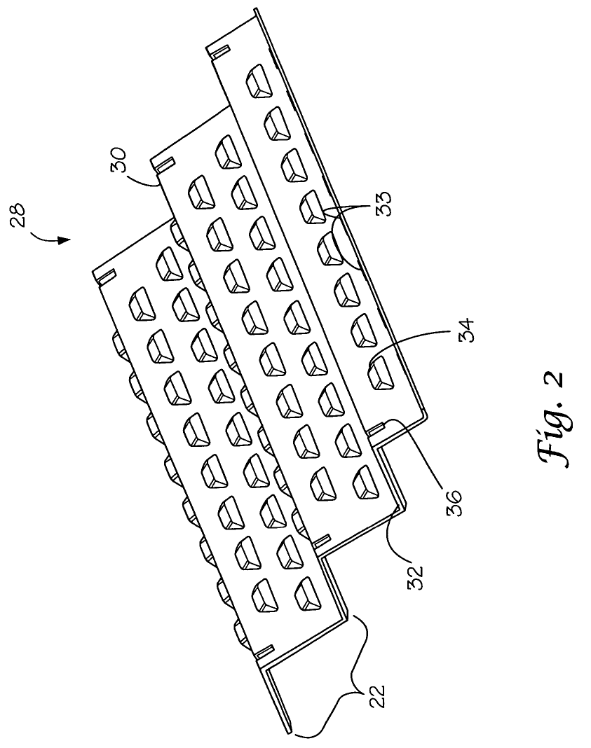

Referring now to FIG. 2, an alternate embodiment of burner shield 28, integrates a plurality of burner shields 22 by connecting a plurality of burner shields to define a plurality of peaks 30 and troughs 32, giving this embodiment of the burner shield an undulating or generally “W” shape. Because this embodiment connects the burner shields rather than placing the burner shields adjacent to one another as shown in FIG. 1, openings 33 can be formed in trough 32 to allow grease that has flowed down from peak 30 to drain from the burner shield and into the drip openings, shown as 26 in FIG. 1.

As can be seen in this embodiment, burner shield 28, regardless of the embodiment used, may be carried by hooks formed in the frame of the grill. The hooks may extend out from the frame and pass through the openings 36 defined in the peaks so that the burner shield rests on the hooks. However, any means generally known in the art for carrying the burner shields may be used for any of the embodiments disclosed.

Regardless of whether the burner shields are integral with one another as shown in FIG. 2 or are arranged in a horizontally spaced relation to one another as shown in FIG. 1, each burner shield 22 includes a protrusion, coined flavor steps, 34 that help to direct the flowing grease and help slow the velocity at which the grease flows down one of the sides of the burner shield, so as to help increase vaporization of the grease.

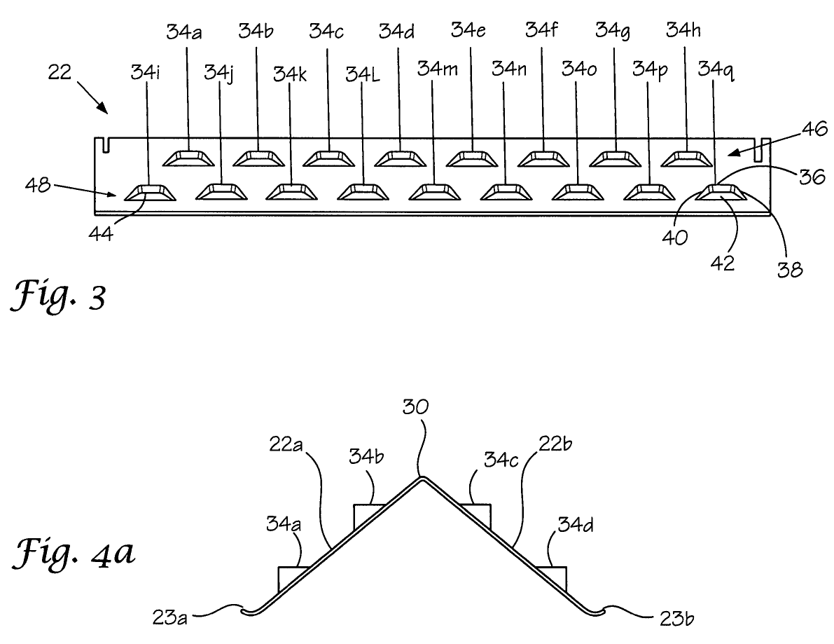

Referring now to FIG. 3, a side view of the burner shield showing protrusions or flavor steps 34()-(q). In the shown embodiment, the flavor step comprises a top side 36, a first side 38, and a second side 40. Each side extends outwardly from the burner shield to help inhibit the flow of grease and increase vaporization of the grease. While it need not be, in at least one embodiment, the top side 36 of the flavor step, protrudes from the burner shield so that it is generally parallel to the cooking surface (shown as 24 in FIG. 1). In alternate embodiments, the top side 36 of the flavor step may protrude from the burner shield 22 so that an angle less than 180 degrees is formed between one of the sides of the burner shield (shown as 22a or 22b in FIG. 1) and top side 36 of protrusion 34.

As can be seen in FIG. 3, in at least one embodiment, a vent 42 is formed by top side 36, first side 38 and second side 40 of the flavor step and at least one of the sides of the burner shield. This vent promotes convection heating of the items being grilled. In this embodiment, the flavor step may further include a front portion 44 that extends downwardly from top side 36, at least partially obstructing the opening 42 that is defined by one of the sides of the burner shield (shown as 22a or 22b in FIG. 1) and flavor step 34.

In alternate embodiments, flavor step 34 need not define an opening 42 in one of the sides 22a and/or 22b of burner shield 22. Further, while the flavor step in the shown embodiment includes a top side 36 a first side 38 and a second side 40, alternate embodiments include steps having alternate configurations. Essentially, all that is required of flavor step 34 is an upper portion that is defined by a protrusion that can slow the velocity or alter the direction of the grease flowing down one of the sides of the burner shield. Such embodiments include a first and second side that protrude from one of the sides of the burner shield and connect to form a radiused peak extending from the burner shield. Also included in such embodiments is a ledge that protrudes from one of the sides of the burner shield at an angle less than 180 degrees as well as a dome that protrudes from the burner shield.

Regardless of the type of flavor step used, in one embodiment, at least two arrangements of flavor steps are carried by at least one side of the burner shield and arranged so that each flavor step in an upper arrangement 46 is positioned so that it may direct the flowing grease to a flavor step in a lower arrangement 48. The angle at which first side 38 and second side 40 of the flavor step are connected to top side 36 of the flavor step is determined in conjunction with the position of each flavor step 34 so that when grease flows down from the peak of the burner shield, the flavor steps in upper arrangement 46 help to direct the grease generally to a flavor step in lower arrangement 48. In at least one embodiment, the rows of flavor steps are arranged so that upper arrangement 46 of flavor steps help direct the flowing grease specifically to top side 36 of a flavor step 34 located in lower arrangement 48.

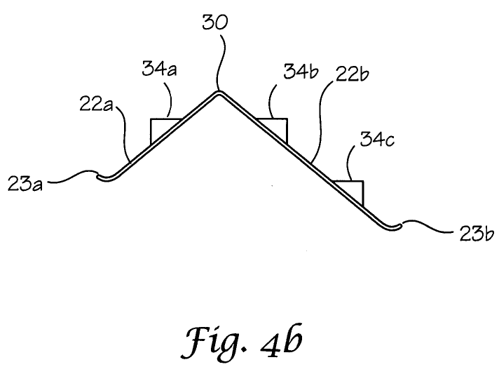

Referring now to FIG. 4a, a first side 22a and a second side 22b of the burner shield 22 define a peak 30. The first and second side extend away from the peak in order to promote the flow of grease towards the flanges 23a and 23b formed at the outer edges of first and second sides 22a and 22b of the burner shield 22. The top side of each flavor step, generally shown as 34a, 34b, 34c and 34d, extends outward from the first and second sides and can be generally parallel to the primary path formed by the cooking grid (shown as 24 in FIG. 1) such that a step is created. This step serves as a stopping or slowing point for grease which drips onto the burner shield.

Referring now to FIG. 4b, first side 22a of burner shield 22 may have a length that is less than the length of second side 22b. In this embodiment, the length of first side 22a may be such that only one arrangement of flavor steps may be disposed on first side 22a. Such an arrangement allows the burner shield to be positioned more closely to the burner (shown as 18 in FIG. 1). For example, if flange 23a is carried by or engaged by the frame to hold burner shield 22 in place, opposite flange 23b is allowed to extend below the portion of the frame which carries flange 50a. Such an arrangement places burner shield 22 in a closer proximity to the flame and exposes the burner shield to a greater degree of heat, thus increasing the vaporization of the grease that drips onto the burner shield.

Typically, this embodiment is used in combination with the embodiment shown in FIG. 2 as a means for disposing the burner shield on the frame (shown as 14 in FIG. 1). In one embodiment, both of the outer edges that are carried by the frame (shown as 14 in FIG. 1) have shorter lengths than the interior sides, thus allowing troughs 32 to be located more closely to the heat source of the grill. However, in an alternate embodiment, burner shield 28 may have only one outer side that is carried by the frame and shorter in length than the interior sides. This embodiment allows burner shield 28 to be sectional, where more than one section is required to cover the entire heat source. In this embodiment, the burner shield may be carried by the frame by hooks that pass through the openings 36 formed in the peaks or by other means generally known in the art.

Modifications to the present invention may occur to those of ordinary skill in the art. Accordingly, it is to be understood that the present invention is not limited to the particular embodiments disclose herein, but rather is intended to cover all modifications within the scope of the present invention as set forth in the following claims.

What is claimed is:

1. A burner shield for placement between the heat source of a grill and the cooking area comprising:
a first side and a second side connected to form a radiused peak having generally an inverted “V” shape, said sides sloping outwardly from said radiused peak; and
a protrusion extending outwardly from at least one of said sides to help inhibit the flow of grease down said at least one of said sides, increasing the time the grease is in contact with said burner shield and to help prevent grease from dripping on said heat source.

2. The invention of claim 1 including a vent defined by said protrusion and said at least one of said sides allowing heat from the heat source to escape through said vent into the cooking area.

3. The invention of claim 1 including:
an upper arrangement of protrusions in generally a horizontally spaced configuration; and
a lower arrangement of protrusions in generally a horizontally spaced configuration and offset from said upper arrangement of protrusions so that grease traveling between protrusions of said upper arrangement of protrusions will contact at least one protrusion of said lower arrangement of protrusions.

4. The invention of claim 1 wherein said protrusion includes a front portion partially obstructing said vent to help prevent grease from dripping on the heat source.

5. The invention of claim 1 wherein said protrusion includes a left portion and a right portion for directing grease away from said vent.

6. The invention of claim 1 including a flange carried by said first side and arranged generally upward from the slope of said first side.

7. The invention of claim 1 wherein said first side has a length less than said second side.

8. A burner shield for placement between the heat source of a grill and the cooking area comprising:
a plurality of integral sides angled to define a plurality of peaks and troughs and arranged generally in an undulating shape; and
a protrusion extending outwardly from at least one of said plurality of integral sides to help inhibit the flow of grease down said at least one of said integral sides, increasing the time the grease is in contact with said burner shield and to help prevent grease from dripping on said heat source.

9. The invention of claim 8 further including at least one opening defined in said plurality of troughs for allowing grease that reaches said plurality of troughs to drain from said burner shield.

10. The invention of claim 8 further including:
an upper arrangement of protrusions in generally a horizontally spaced configuration; and
a lower arrangement of protrusions in generally a horizontally spaced configuration and offset from said upper arrangement of protrusions so that grease traveling between protrusions of said upper arrangement of protrusions will contact at least one protrusion of said lower arrangement of protrusions.

11. The invention of claim 8 further including a vent defined by said protrusion and said at least one of said plurality of integral sides.

12. The invention of claim 8 having:
a first exterior integral side; and
a second exterior integral side having a length less than said first exterior integral side.

13. The invention of claim 7 having:
a first exterior integral side;
a second exterior integral side;
a plurality of interior integral sides; wherein
said first and second exterior integral sides having a length less than said plurality of said interior integral sides.

14. A cooking appliance comprising:
a frame;
a cooking surface carried by said frame of said cooking appliance;
at least one heat source carried by said frame and disposed beneath said cooking surface for heating said cooking surface;
a burner shield having a first side and a second side carried by said frame and connected to form a radiused peak having generally an inverted V shape, said sides sloping outwardly from said radiused peak;
a protrusion extending outwardly from at least one of said sides of said burner shield; and
said protrusion extending outwardly from said at least one of said sides of said burner shield to help inhibit the flow of grease down said at least one of said sides, increasing the time the grease is in contact with said burner shield and to help prevent grease from dripping on said heat source.

15. The invention of claim 14 including a vent defined by said protrusion and one of said sides of said burner shield for providing convection heating.

16. The invention of claim 15 wherein said protrusion further includes a front portion partially obstructing said vent.

17. The invention of claim 14 wherein said burner shield further includes:
an upper arrangement of protrusions in generally a horizontally spaced configuration; and
a lower arrangement of protrusions in generally a horizontally spaced configuration and offset from said upper arrangement of protrusions so that grease traveling between protrusions of said upper arrangement of protrusions will contact said at least one protrusion of said lower arrangement of protrusions.

18. The invention of claim 14 including:
a plurality of integral sides angled to define a plurality of peaks and troughs and arranged generally in an undulating shape; and
a protrusion extending outwardly from at least one of said plurality of integral sides to help inhibit the flow of grease down said at least one of said integral sides, increasing the time the grease is in contact with said burner shield and to help prevent grease from dripping on said heat source.

19. The invention of claim 18 having:
an upper arrangement of protrusions in generally a horizontally spaced configuration; and
a lower arrangement of protrusions in generally a horizontally spaced configuration and offset from said upper arrangement of protrusions so that grease traveling between protrusions of said upper arrangement of protrusions will contact said at least one protrusion of said lower arrangement of protrusions.

20. The invention of claim 18 including a vent defined by said protrusion and said at least one of said plurality of integral sides.
